(19) United States
(12) Patent Application Publication
(10) Pub. No.: US 2009/0052041 A1
(43) Pub. Date: Feb. 26, 2009

(54) Anti-Reflection Film and Polarizing Plate Using the Same

(75) Inventors: Yuki Watanabe, Tokyo (JP); Kazutoshi Kiyokawa, Tokyo (JP); Jyunko Awa, Tokyo (JP); Yasunori Kurauchi, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing, Co., Ltd., Tokyo (JP)

(21) Appl. No.: 12/193,570

(22) Filed: Aug. 18, 2008

(30) Foreign Application Priority Data
Aug. 20, 2007 (JP) 2007-213348

(51) Int. Cl. G02B 1/11; B32B 5/00

(52) U.S. Cl. 359/586; 428/336

(57) ABSTRACT

An anti-reflection (AR) film has a transparent substrate film; a hard coat layer which is formed on one surface of the transparent substrate film; and an AR layer which is formed on the hard coat layer. And the AR layer has a four-layer stacked structure of alternate high and low refractive index material layers; the total thickness of the low refractive index material layer is in the range 90-130 nm; and the arithmetic mean roughness Ra of the AR layer surface is in the range 1.5-3.0 nm.

### CROSS REFERENCE TO RELATED APPLICATION

This application is based on and claims the benefit of priority from the Japanese Patent Application number 2007-213348, filed on Aug. 20, 2007; the entire contents of which are incorporated herein by reference.

### BACKGROUND OF THE INVENTION

1. Field of the Invention

This invention relates to an anti-reflection (AR) film and a polarizing plate to which the AR film is applied. In particular, this invention relates to a polarizing plate or its AR film which has high density, strong mechanical resistance and high level of degradation resistance achieved by using hydrolytically-stable passivation film etc.

2. Description of the Related Art

An AR film is attached to many optical display devices such as LCD (Liquid Crystal Display), CRT (Cathode Ray Tube display), PDP (Plasma Display Panel) and etc. The AR film serves to prevent the display devices from reflecting outside light such as sunlight or fluorescent lighting. Recently, as mobile tools such as DSC (Digital Still Camera), cell phone and DVC (Digital Video Camera) etc. and vehicle navigation equipment are widely used, display devices tend to be used more and more outdoors.

An AR film with nearly-zero reflectance is demanded for outdoor use because the sunlight causes strong reflection on a display device surface. In general, AR films are produced by means of dry coating techniques which enable the formation of a multi-layer thin film of nanometers thickness. Among them, sputtering method provides films which have more uniform thickness and less defects such as pinholes so that it serves to produce a film with higher level of visibility than other dry coating techniques such as vacuum deposition method, ion plating method, and CVD (Chemical Vapor Deposition) method etc. In addition, since high dense film production is achieved, it is possible to form a film with superior mechanical strength by the sputtering method.

An AR layer laminated stacking on a passivation layer of a polarizing plate is often used in LCD application. In recent years, high endurance polarizing plates or AR films are required as they are increasingly used in vehicles or outdoors etc. Generally, TAC (Tri Acetyl Cellulose) film has been used as a passivation film of a polarizing plate because it is highly hygroscopic. TAC films are hydrolyzed, however, under an extreme condition of high temperature, or at the same time, high humidity as well. Hence the lack of endurance of the passivation films is a problem to be solved.

To overcome this problem, various AR films with vapor barrier properties are under development. Patent Document 1 discloses a technology for forming an AR layer which has a barrier performance less than half of that of a substrate. Patent Document 2 discloses a technology for forming an (300-1000 g/m²/day of) optically-transparent inorganic layer on one surface and a (0-10 g/m²/day of) barrier layer on the other surface of a plastic film.

As display devices are used outdoors more frequently these days, endurance at extremely high temperature (around 100° C. for vehicle equipment applications etc. in particular) is required. At this time if vapor barrier performances are too high, it is indeed that almost no moisture is allowed to pass in from outside. But moisture produced by the polarizing plate or the TAC film conversely remains in the AR layer and weakens its endurance. From this point of view, development of an AR film which has a high vapor transparency from inside to outside is desired.

This invention provides an AR film which is dense and has high mechanical properties (such as rub resistance) as well as high vapor transparency, endurance at high temperature and humidity. This invention also provides a polarizing plate to which the AR film is applied.

Patent Document 1: JP 2004-53797 A (Laid-Open publication)
Patent Document 2: JP Hei10-10317 A (Laid-Open publication)

### SUMMARY OF THE INVENTION

One embodiment of this invention is an anti-reflection (AR) film comprising: a transparent substrate film; a hard coat layer formed on one side of the transparent substrate film; and an AR layer formed on the hard coat layer, wherein the AR layer has a stacked structure of four or more layers alternating high and low refractive index layers, wherein the AR layer has a low refractive index layer as the outermost layer, the AR layer has a total thickness of 90-130 nm, and wherein the outermost layer of the AR layer has an average roughness of 1.5-3.0 nm.

### BRIEF DESCRIPTION OF THE DRAWINGS

FIG. 1 shows a schematic cross section view illustrating the structure of an AR film of this invention.

FIG. 2 shows a schematic cross section view illustrating a polarizing plate which has an AR layer of this invention.

### DESCRIPTION OF REFERENCE NUMERALS AND SIGNS

1: Transparent substrate film
2: Hard coat layer
3: Primer layer
4: Anti-reflection (AR) layer
5: Antifouling layer
10: Polarizing film (polyvinyl alcohol film)
100: Anti-reflection (AR) film
101: Polarizing plate which has an AR film

### DETAILED DESCRIPTION OF THE INVENTION

Referring to the figures, an embodiment of this invention is described in detail below. An identical number refers to an identical constituent part. Descriptions common to some embodiments are not repeated every time.

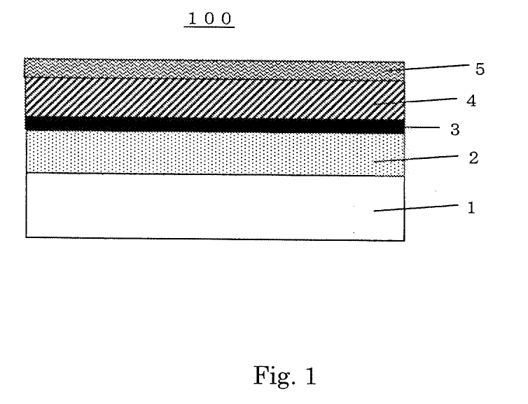

FIG. 1 shows a schematic cross section view illustrating an AR film 100 of this invention. A hard coat layer 2, a primary layer 3, and an AR layer 4 are sequentially stacked on a transparent substrate film 1 as shown in FIG. 1. In addition, an antifouling layer 5 is laminated on the AR layer 4.

A surface protecting material for a polarizing polyvinyl alcohol film is available as a transparent substrate film 1 of this invention.

Although there are no restrictions on the transparent substrate film 1 as long as effects of this invention appear, particularly cellulose acetate series resins such as TAC etc. are preferably used for they have high passivating characteristics. At this time, cellulose acetate resins of any acetification degree are available. Thickness of the transparent substrate film 1 can be determined appropriately (about 25-300 μm usually) according to the application of the product. In addition, the transparent substrate film 1 can contain additive agents such as plasticizer, UV absorber and anti-degradation agent etc.

On the transparent substrate film 1 can be formed a hard coat layer 2 which will help later to give the AR layer 4 a sufficient mechanical strength.

An ionizing ray curable or ultraviolet (UV) curable resin, or a thermosetting resin is used as the hard coat layer of this invention. Among them, acrylic resins such as UV curable acrylic acid esters, acrylamides, methacrylic acid esters and methacrylamides etc., silicone resins and polysiloxane resins are the most preferable.

A polymerization initiator may be added to the resin in order to improve curing property. The hard coat layer 2 should have a thickness of 0.5 μm or more, preferably in the 3 μm to 20 μm range. In addition, the hard coat layer 2 may receive an anti-glare (AG) treatment by which transparent fine particles of 0.01-3 μm on an average in size are dispersed.

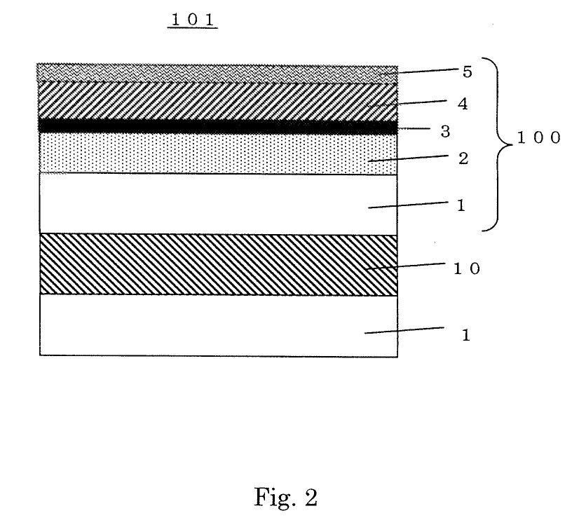

After the hard coat layer 2 is formed, it is preferred that the transparent substrate film 1 receive an alkali saponification treatment. Especially when a TAC film is applied as the transparent substrate film 1, the TAC film is preferred to receive an alkali saponification treatment, which provides hydroxyl groups to hydrolyze ester functions, because the adhesiveness with the polarizing film 10 (polyvinyl alcohol film) fixed in a post-process will significantly improve (See FIG. 2). In addition, the adhesiveness between the hard coat layer 2 and its adjacent layer which will be formed later also improves since an alkali saponification treatment is performed by wet processing, in which slight erosion, corrosion and infiltration take place.

Moreover, the hard coat layer 2 may receive a surface treatment on the opposite side of the surface which meets the transparent substrate film 1. The surface treatment at this time is, for example, corona discharge treatment, electron beam treatment, flame treatment, glow discharge treatment and atmospheric-pressure plasma treatment etc.

It is preferred that a low-temperature plasma surface treatment is performed in the embodiment of this invention. A low temperature plasma surface treatment serves to improve hydrophilicity, and producing a moderate surface roughness it also serves to improve adhesiveness with a following stacking layer.

Then, a primer layer 3 can be formed on the hard coat layer 2. The material of the primer layer 3 of this embodiment of the invention is, for example, a metal such as silicon, nickel, chromium, aluminum, tin, gold, silver, platinum, zinc, titanium, tungsten, zirconium or palladium etc., or an alloy which includes two or more of these metals. Furthermore, examples of the material include oxides, fluorides, sulfides or nitrides etc. of these metals or a mixture of them as well. But this is not all. In addition, the primer layer 3 may be composed of two layers or more, too.

The primer layer 3 of this embodiment of the invention helps to improve adhesiveness. The primer layer 3 should be thin enough to keep transparency of the transparent substrate film 1 and it is preferable that it has a thickness of around 1-10 μm. The primer layer 3 is preferred to be formed by means of a dry coating technique such as the sputtering method, reactive sputtering method, vacuum deposition method, ion plating method or chemical vapor deposition (CVD) method. Particularly, the sputtering method is preferable in this invention.

As the sputtering method makes it possible to produce a layer which has a precisely controlled uniformity in thickness and few defects such as pinholes, the resulting AR film and polarizing plate have an advantage of high level of visibility and high yield in manufacturing. Moreover, the sputtering method produces a significant by dense layer so that it is possible to form an AR layer 4 which has a high level of mechanical strength such as rub resistance etc. In addition, a layer produced by means of this sputtering method has a high level of vapor barrier property since it has high density. The AR layer 4 which is composed of these optical thin film layers is formed by means of a dry coating technique such as the sputtering method, reactive sputtering method, vacuum deposition method, ion plating method or chemical vapor deposition (CVD) method.

In particular, the sputtering method, which produces a layer with high visibility due to excellent thickness uniformity and few defects such as pinholes along with a high level of mechanical strength such as rub resistance due to its dense film structure, is preferable. Above all, the dual magnetron sputtering (DMS) method, which produces a layer film by a midfrequency voltage application, is most preferable since it shows higher productivity by a higher film-deposition rate and a high level of discharge stability.

Metals such as Indium, tin, titanium, silicon, zinc, zirconium, niobium, magnesium, bismuth, cerium, tantalum, aluminum, germanium, potassium, antimony, neodymium, lanthanum, thorium and hafnium etc. and alloy of two and more of these metals are available as a high refractive index material for the transparent thin film layer. In addition, oxides, fluorides, sulfides and nitrides etc. of these metals, specifically, titanium oxide, niobium oxide, zirconium oxide, tantalum oxide, zinc oxide, indium oxide and cerium oxide etc., which have a refractive index equal to or more than 1.9 are also included in these examples. This invention, however, is not limited to these materials. Moreover, when the transparent thin film layer is not made of a single layer but a multilayer, each layer material does not have to be identical and can be selected appropriately depending on the respective purpose. Especially in the case where sputtering deposition technique is applied, niobium oxide is the most proper material, which produces less pinholes.

For example, silicon oxide, titanium nitride, magnesium fluoride, barium fluoride, calcium fluoride, hafnium fluoride and lanthanum fluoride etc., which have a refractive index equal to or less than 1.6 are available as a low refractive index material for the transparent thin film layer. This invention, however, is not limited to these materials. Moreover, when the transparent thin film layer is not made of a single layer but a multilayer, each layer material does not have to be identical and can be selected appropriately depending on the respective purpose. In particular, considering optical characteristics, mechanical strength, costs and deposition processing suitability, silicon oxide may be the most appropriate material.

Here, water vapor permeability of the AR film 100 depends on thicknesses and the kinds of the substrate material and the functional layer material as well as a temperature and humidity. A temperature dependence of a moisture permeation rate is expressed by the Arrhenius equation noted below.

$$P = {P}_{0} {e}^{- \frac{E}{RT}} \qquad [ Mathematical formula 1 ]$$

P: Moisture permeation rate (namely, water vapor permeation rate per unit thickness and per unit difference of water vapor pressure).
P0: Moisture permeation rate at absolute zero temperature.
E: Activation energy of moisture permeation.
R: Gas constant.
T: Absolute temperature.

The moisture permeation rate of a 100 μm thick TAC film, which is widely used as a surface passivation layer of the polarizing plate 101, is in the range 120-160 g/m²/day at a temperature of 25° C. and relative humidity of 90%, and 380 g/m²/day at a temperature of 40° C. and relative humidity of 90%. By forming various layers stacked on this TAC film, it is able to make it difficult for water vapor to permeate the TAC film. In particular, the moisture permeation rate of the AR layer 4 which has excellent mechanical strength and is made of stacked dense layers becomes almost zero so that an excellent moisture barrier performance is achieved. Above all, a layer produced by the sputtering technique has a dense membrane structure and a high level of moisture barrier performance.

If the moisture barrier performance is too high at this time, it becomes difficult for moisture contained inner the AR film 100 to escape outside so that undesirable moisture remains which causes a decrease of endurance. Thus, when the AR layer 4 is applied to an AR film 100 which is required for an environmental endurance, it is necessary to improve the overall AR film's property to increase the water vapor permeation rate.

In the case where the AR layer 4 has a structure of stacked inorganic multilayer, if at least one layer out of the multilayer provides an excellent moisture barrier performance, the overall AR film which includes the AR layer 4 also achieves a high level of moisture barrier performance. And comparing layers of same level of moisture barrier property, the thicker a layer is, the higher moisture barrier performance will be obtained.

In this embodiment of this invention, the thickness of the low refractive index layer which is made of silicon oxide and sits in the AR layer 4 is made in the range 90-130 nm and the arithmetic mean roughness Ra of the AR layer 4 is in the range 1.5-3.0 nm in order to improve water vapor permeability still and keep the dense structure of the layer, which is a major feature of the sputtering deposition process. Hence, it becomes possible to produce an AR layer 4 which has adequate water vapor permeability along with a high adhesiveness and a high level of endurance.

The low refractive index layer which is in the AR layer 4 and made of silicon oxide in this embodiment of this invention does not provide a sufficient antireflective performance if its total thickness is less than 90 nm. On the other hand, the low refractive index layer loses sufficient endurance (for example at a high temperature and humidity) if its total thickness exceeds 130 nm.

If the arithmetic mean roughness Ra of the AR layer surface in this embodiment of this invention is less than 1.5 nm, its water vapor permeability becomes too low due to its high dense structure. Then, moisture generated by the polarizing film (polyvinyl alcohol film) 10 and/or the transparent substrate film (TAC film) 1 in the rest process of polarizing plate production remains in the film so that its heat resistance and endurance at high temperature and humidity etc. are not sufficiently achieved. On the other hand, if the arithmetic mean roughness Ra exceeds 3.0 nm, adequate mechanical characteristics such as rub resistance and adhesiveness are not obtained.

There are several methods to obtain the arithmetic mean roughness Ra of the AR layer 4 surface in the 1.5 nm to 3.0 nm range. In particular, it is easy to realize this by sputtering method adjusting the deposition pressure appropriately. The appropriate deposition pressure for the sputtering method is 0.5-2.0 Pa and 0.8 Pa is the most preferable. If the deposition pressure is in the range 0.5-2.0 Pa, a porous layer but still possessing a strong mechanical property which is specifically achieved by means of sputtering, can be produced and it is possible to obtain an AR layer 4 which has high level of endurance. If necessary, an antifouling layer 5 can be formed on the AR layer 4 as the outermost coat. The antifouling layer 5 is made from a fluorine-containing silicon compound which has two or more of silicon atoms each bonding to a reactive functional group. A reactive functional group of this embodiment of this invention means a functional group which reacts and is able to bond with an outermost part of the AR layer 4. The antifouling layer 5 is formed by reacting the fluorine-containing silicon compounds with each other. This layer makes it difficult to be blotted or even if blotted, makes it easy to wipe it out. When the antifouling layer 5 is formed on the AR layer 4, it is prefer that the arithmetic mean roughness Ra of the antifouling layer surface is in the 1.0 nm to 5.0 nm range.

In order to keep adequate water vapor permeability along with sufficient adhesiveness, the AR film 100 of this embodiment of this invention is preferred to have moisture permeability of 20 g/m²/day or more at a temperature of 40° C. and humidity of 90% RH. To be more precise, moisture permeability in the range 35-250 g/m²/day is more preferable.

Next, the polarizing plate 101 which includes this AR film 100 will be described with reference to FIG. 2. FIG. 2 is a schematic cross section diagram illustrating the polarizing plate 101 which includes the AR film 100 of this embodiment of this invention. This polarizing plate 101 can be produced as follows: The AR film 100, a polarizing film 10 which is dyed with iodine and a transparent substrate film 1 made from the same material as the AR film's substrate film 1 which sits on the opposite side of the polarizing film 10 are arranged in this order; then, these three items are combined. Needless to say, except for the structure of the AR film 100, any other heretofore known technology can be applied to this invention.

### PRACTICAL EXAMPLES

Practical examples of this invention along with comparative examples will be described below. This invention, however, is not limited to the following practical examples (e.g. the thickness of the AR layer 4 etc.).

As is shown in FIG. 2, a U/V curable acrylic resin was coated on a TAC film of 80 μm in thickness as the substrate film 1 and dried. After exposed to a UV light to form a 5 μm hard coat layer 2, the hard coat layer 2 along with its transparent substrate film 1 was immersed in 40° C. of 1.5 N-NaOH aqueous solution for 2 minutes. Then it was washed with water and dried. Afterward, this saponified hard coat layer 2 was received a glow plasma treatment and a 3 nm SiO layer was deposited on it by means of sputtering technique. Then after an AR layer 4 with a determined structure and determined thickness was formed stacked by sputtering, the arithmetic mean roughness Ra and the water vapor permeability of the AR film's surface were measured.

### Practical Example 1

The deposition process was carried out in such a way that the deposition pressure of forming the AR layer 4 was 0.8 Pa and the layer structure of the AR layer 4 from the hard coat layer's side was Nb₂O₅/SiO₂ /Nb₂O₅ /SiO₂ each of which had a thickness of 15 nm /25 nm /105 nm /85 nm.

### Practical Example 2

The deposition process was carried out in such a way that the deposition pressure of forming the AR layer 4 was 1.2 Pa and the layer structure of the AR layer 4 from the hard coat layer's side was Nb₂O₅ /SiO₂ /Nb₂O₅/SiO₂ each of which had a thickness of 15 nm /25 nm /105 nm /85 nm.

### <Comparative Example 1>

The deposition process was carried out in such a way that the deposition pressure of forming the AR layer 4 was 0.8 Pa and the layer structure of the AR layer 4 from the hard coat layer's side was SiO₂ /Nb₂O₅ /SiO₂ /Nb₂O₅ /SiO₂ each of which had a thickness of 20 nm /25 nm /25 nm /60 nm /96 nm.

### Comparative Example 2

The deposition process was carried out in such a way that the deposition pressure of forming the AR layer 4 was 0.8 Pa and the layer structure of the AR layer 4 from the hard coat layer's side was Nb₂O₅ /SiO₂ /Nb₂O₅ /SiO₂ each of which had a thickness of 31 nm /8 nm /63 nm /68 nm.

### Comparative Example 3

The deposition process was carried out in such a way that the deposition pressure of forming the AR layer 4 was 0.3 Pa and the layer structure of the AR layer 4 from the hard coat layer's side was Nb₂O₅ /SiO₂ /Nb₂O₅ /SiO₂ each of which had a thickness of 15 nm /25 nm /105 nm /85 nm.

### Comparative Example 4

The deposition process was carried out in such a way that the deposition pressure of forming the AR layer 4 was 2.5 Pa and the layer structure of the AR layer 4 from the hard coat layer's side was Nb₂O₅ /SiO₂ /Nb₂O₅ /SiO₂ each of which had a thickness of 15 nm /25 nm /105 nm /85 nm.

As illustrated in FIG. 2, a polarizing film (polyvinyl alcohol film) 10 which had a thickness of 25 μm and was dyed with iodine together with an 80 μm thick transparent substrate film 1 was combined to the another surface (under side) of the AR film 100 produced as described above to obtain the polarizing plate 101 which had an antireflective function.

### <Evaluation>

Each sample which was obtained in the practical examples and the comparative examples was evaluated as follows. The results are shown in Table 1.

### <1>Reflectance

A reflectance was measured by means of a U4000 type spectrophotometer made by Hitachi, Ltd. The rear side of each sample received a coating treatment to cut the reflection by a matte-black spraying. A measurement unit for 5° in specular direction was used for measurements.

### <2>Mechanical Strength

Steel wool #0000 was fixed on rub resistance test equipment. Then a rub resistance test in which the AR layer of each sample was rubbed 10 laps in reciprocating motion under a 500 gf of load was performed. The wear status (e.g. the number of abrasion flaws) was observed visually. Criteria were as follows.
O: No abrasion flaws.
Δ: Abrasion flaws less than 10.
X: Abrasion flaws of 10 or more.

### <3>Heat Resistance

Each polarizing plate 101 which was produced in the practical examples and comparative examples was pasted on a glass with a tacky film. Then it was kept in a thermostatic humidity-stable chamber which was set at a temperature of 95° C. and dry condition of 5% RH for 500 hours to evaluate its endurance. It was checked whether there was TAC film deterioration caused by hydrolysis etc. by means of a human smell (judging whether it smells acetic acid or not) and an infrared spectroscopy measurement (time dependency of the absorption of carbonyl group).
O: No deterioration.
Δ: Slight deterioration.
: Heavy deterioration.

### <4>Endurance at a High Temperature and Humidity

Each polarizing plate 101 which was produced in the practical examples and comparative examples was pasted on a glass with a tacky film. Then it was kept in a thermostatic humidity-stable chamber which was set at a temperature of 60° C. and humidity of 95% RH for 500 hours to evaluate its endurance. It was checked whether there was TAC film deterioration caused by hydrolysis etc. by means of a human smell (judging whether it smells acetic acid or not) and an infrared spectroscopy measurement (time dependency of the absorption of carbonyl group).
O: No deterioration.
Δ: Slight deterioration.
X: Heavy deterioration.

### <5>Water Vapor Permeability

Water vapor permeability of each AR film 100 which was in its stage before combining a polarizing film (polyvinyl alcohol film) 10 was measured under the condition of a temperature of 40° C. and humidity of 90% RH. The water vapor permeability measurement was carried out in a way conformable to JIS Z0208.

### <6>Arithmetic Mean Roughness

Arithmetic mean roughness measurement (JIS B 0601) of an AR film 100 surface was performed by an atomic force microscope (AFM), Nanoscope IIIa (made by Digital Instruments Corp.). The measured area was determined to be a 1 μm×1 μm.

TABLE 1

| | PE | PE | CE | CE | CE | CE |
|---|---|---|---|---|---|---|
| | 1 | 2 | 1 | 2 | 3 | 4 |
| Total thickness of SiO₂ | 110 | 110 | 141 | 76 | 110 | 110 |
| layer [nm] | | | | | | |
| Reflectance [%] | 0.1 | 0.1 | 0.2 | 0.9 | 0.1 | 0.1 |
| Mechanical Strength | ◯ | ◯ | ◯ | ◯ | ◯ | X |
| Heat Resistance | ◯ | ◯ | X | ◯ | X | ◯ |
| Endurance at a high temp. | ◯ | ◯ | Δ | ◯ | X | ◯ |
| and humidity | | | | | | |
| Water Vapor permeability | 35 | 65 | 18 | 50 | 5 | 125 |
| [g/m²/day] | | | | | | |
| Arithmetic mean roughness | 1.9 | 2.3 | 1.9 | 1.9 | 1.3 | 3.2 |
| [nm] | | | | | | |

PE: Practical example,
CE: Comparative example.

The effect of this invention was evident in the polarizing plate 101 which included the AR film 100 produced in the practical examples 1 or 2 since it had remarkably low reflectance of 0.2 or less, excellent mechanical strength and endurance. In contrast, it was evident that the samples produced in the comparative example 1 and 3 showed deteriorations in the heat resistance test and endurance test at high temperature and humidity. As for the sample produced in the comparative example 4, there was a problem in rub resistance although it had excellent heat resistance and endurance at high temperature and humidity. And the sample produced in the comparative example 2 was apparently inferior to others in antireflective performance although it showed good mechanical strength and endurance.

What is claimed is:

1. An anti-reflection (AR) film comprising:
a transparent substrate film;
a hard coat layer which is formed on one surface of the transparent substrate film; and
an AR layer which is formed on said hard coat layer, said AR layer having a four-layer stacked structure of alternate high and low refractive index material layers, the total thickness of said low refractive index material layer being in the range 90-130 nm, and the arithmetic mean roughness Ra of said AR layer's surface being in the range 1.5-3.0 nm.

2. The AR film according to claim 1, wherein said low refractive index material layer includes silicon oxide.

3. The AR film according to claim 1, wherein said low refractive index material layer consists of silicon oxide.

4. The AR film according to claim 1, wherein said AR layer is formed by sputtering technique with a deposition pressure in the 0.5-2.0 Pa range.

5. The AR film according to claim 1, wherein a primer layer comprising one or more layer(s) which includes a metal; alloy; metal compound; or a mixture made of metal, alloy or metal oxide, is formed between said hard coat layer and said AR layer.

6. The AR film according to claim 1, wherein an antifouling layer is formed on said AR layer.

7. The AR film according to claim 5, wherein the arithmetic mean roughness Ra of said antifouling layer surface is 1.0-5.0 nm.

8. The AR film according to claim 1, wherein said transparent substrate film includes a TAC film.

9. The AR film according to claim 1, wherein said transparent substrate film consists of a TAC film.

10. The AR film according to claim 1, wherein water vapor permeability at a temperature of 40° C. and humidity of 90% RH is 20 g/m²/day or more.

11. A polarizing plate which comprises said AR film according to claim 1.
